(19) United States
(12) Patent Application Publication
(10) Pub. No.: US 2004/0149933 A1
(43) Pub. Date: Aug. 5, 2004

(54) Method and devices for adjusting an electron-beam used in an electron beam proximity exposure apparatus

(76) Inventor: Yukisato Kawamura, Tokyo (JP)

Correspondence Address: CHRISTIE, PARKER & HALE, LLP, 350 WEST COLORADO BOULEVARD, SUITE 500, PASADENA, CA, 91105, US

(21) Appl. No.: 10/762,055

(22) Filed: Jan. 20, 2004

(30) Foreign Application Priority Data
Jan. 24, 2003 (JP) 2003-016337

(51) Int. Cl. G21G 5/00

(52) U.S. Cl. 250/492.1

(57) ABSTRACT

The present invention relates methods and devices for adjusting an electron beam used in an electron-beam of the electron-beam proximity exposure apparatus, wherein the method of present invention comprising the step of: forming the electron-beam by passing through a aperture which has a predetermined length part, into a measurement beam which has a cross section having a measurement part thereof corresponding to the predetermined length part of the aperture, memorizing the calibrating information including the electron-beam, wherein the measured lengths are the length of the measurement part of the cross section of the measurement beam measured at a predetermined distance from the aperture under the states of the electron-beam, and each of the states of the electron-beam indicated by the information indicating the state of the electron-beam is memorized in relation to each of the measured lengths, measuring the length of the measurement part of the cross section of the measurement beam at a predetermined distance from the aperture, and calibrating the state of the electron-beam of the electron-beam proximity exposure apparatus on the basis of the length measured in the measuring step in accordance with the calibrating information.

### BACKGROUND OF THE INVENTION

1. Field of the Invention

The present invention relates to methods and devices for adjusting an electron-beam used in an electron-beam proximity exposure apparatus and, in particular to methods and devices for adjusting the state of the parallelism and/or of the astigmatism of such electron-beams.

2. Description of the Related Art

Referring to FIG. 1, there is shown an electron-beam proximity exposure apparatus as described in U.S. Pat. No. 5,821,272. The electron-beam proximity exposure apparatus 1 mainly comprises an electron gun 15 including an electron source 5 which provides a beam of electrons 3, a lens 7 which forms the a beam of electron 3 into a parallel beam, a Y-axis astigmatism correction coil 9 and a X-axis astigmatism correction coil 11, and a beam limiting aperture 13, a scanning means 25 including main sets 17, 19 of deflectors and sub sets 21, 23 of deflectors, which scans the electron-beam horizontally, a mask for exposing 27, an electrostatic chuck 29, and an XY-stage 31.

The mask for exposing 27 is disposed close to a wafer 33 adsorbed on the electrostatic chuck 29. The resist layer 35 on the wafer 33 is irradiated by the electron of the beam passing through the openings corresponding to the mask pattern of the mask 27 when the electron-beam 3 irradiates the mask 27 vertically, and, therefore, the mask pattern will be exposed to the resist layer 35 at the same size.

However, if the electron-beam 3 passing through the mask pattern of the mask 27 is not a parallel beam, the mask pattern cannot be exposed to the resist layer 35 at the same size. FIG. 2A is a side view of the parallel beam 3 and the non-parallel beams 3′, 3″ passing through the opening 37 of mask 27. FIG. 2B is a top view of the opening 37 and portions of the resist layer 35 irradiated by the non-parallel beams 3′, 3″ which pass through the opening 37. When the electron-beam widens or narrows after passing through the opening 37 as the non-parallel beams 3′ and 3″ as shown in FIG. 2A, the irradiated portion of the resist layer 35 also become larger or smaller than the opening 37 as the portion 3′ and 3″ as shown in FIG. 2B. Thus the operator must constantly adjust lens 7 such that the electron-beam 3 may become parallel and the irradiated portions of layer 35 are as large as the openings of the mask 27.

Moreover, if the electron-beam 3 has astigmatism, the cross section of the beam becomes deformed elliptically as the beam progresses. If the electron-beam 3 has astigmatism, as shown in FIG. 3 illustrates, for example, the portion 39 irradiated by the beam 3 passing through the opening 37 of the mask 27 is deformed by the astigmatism of the beam 3. An electron-beam having astigmatism cannot be focused well.

The astigmatism of the electron-beam can be corrected by an octupole coil. FIG. 4 shows the top view of the octupole coil which is constructed in combination of the Y-axis astigmatism correction coil 9 and the X-axis astigmatism correction coil 11, wherein the Y-axis astigmatism correction coil 9 is composed of coils YC11, YC12, YC21, and YC22, and the X-axis astigmatism correction coil 11 is composed of coils XC11, XC12, XC21, and XC22. As shown in FIG. 4, the X-axis astigmatism correction coil 11 is disposed on 45-degree angle with the Y-axis astigmatism correction coil 9, and the each of pairs of coils YC11 and YC12, YC21 and YC22, XC11 and XC12, and X21 and XC22 are disposed oppositely. The Y1 and Y2 directions relating to the Y-axis, and the X1 and X2 directions relating to the X-axis are defined as shown in FIG. 4.

In addition, the Y-axis astigmatism correction coil 9 and the X-axis astigmatism correction coil 11 are indicated separately in FIGS. 1, 10 and 22 although these coils are provided in one plane typically. This does not affect to the present invention.

The adjustment of the astigmatism of the electron-beam 3 is performed in the following way. If the electron-beam 3 has the cross section 39 shown in FIG. 4, for example, current is passed through the coil YC11 and YC12 such that the electron-beam 3 is affected by the magnetic field caused by the coil Y11 and Y12 to be focused in the Y1 direction and, concurrently, the current is passed through the coil YC21 and YC22 such that the electron-beam 3 is affected by the magnetic field caused by the coil YC21 and YC22 to be diverged in the Y2 direction. The current is passed through the coil XC11 and XC12 such that the electron-beam 3 is affected by the magnetic field caused by the coil XC11 and XC12 to be focused in the X1 direction, concurrently and, the current is passed through the coil XC21 and XC22 such that the electron-beam 3 is affected by the magnetic field caused by the coil XC21 and XC22 to be diverged in the X2 direction. Hence, the adjustment of the astigmatism of both of the directions relating to the Y-axis and the X-axis is performed.

### SUMMARY OF THE INVENTION

Conventionally, an adjusting for the focus and astigmatism of the electron-beam of the electron-beam proximity exposure apparatus has been performed by skillful operators of the apparatus. The operators typically adjust the lens 7 and the astigmatism correction coils 9,11 while observing the images generated by secondary electrons detected by secondary electron detector. Alternatively, the operators expose a predetermined test pattern to a resist layer on the wafer at a predetermined spacing, and determine whether the test pattern is transferred as expected or not by measuring the line width or the deformation of the exposed pattern. Then, they adjust the lens 7 and the astigmatism correction coils 9, 11 on the basis of the result of said measurement.

Said the focus and astigmatism adjustments consume much of work and time and, moreover the operation for the adjustment needs skill. Thus, the operation for the adjustment not only has an adverse affect on the throughputs and the extraction rates of the lithography apparatus, but also causes differences of the performance between the apparatuses due to the ways of adjustment by different operators.

The object of the present invention is to provide methods and devices for adjusting a degree of the parallelism and a degree of the astigmatism of the electron-beam of the electron-beam proximity exposure apparatus, which allow an automatic and quick adjustment in accordance with a predetermined evaluation method, to solve the above-mentioned problems.

In order to solve the problems, the method of adjustment in accordance with the present invention uses an aperture which has a predetermined length part, such as a slit which has a rectangular opening having predetermined line width.

Then, the cross section of the electron-beam formed by passing through the aperture, herewith the beam which has a cross section having a part corresponding to the predetermined length part of the aperture, is formed (hereinafter referred to as “the measurement beam”). In the cross section of the measurement beam, a measurement part corresponding to the predetermined length part of slit is formed.

Then, the length of the measurement part is measured at a predetermined distance from the aperture such that the measured length varies in response to the variation of the state of electron-beam, such as the state of a degree of the parallelism (i.e. the focus), the state of a degree of the astigmatism of the electron-beam and so on. The calibration of the state of the electron-beam is performed on the basis of the measured length. Herein, the state of a degree of the parallelism or the state of a degree of astigmatism may be used as the state of the electron-beam.

Referring to the FIG. 5, the method of the calibration of a degree of the parallelism of the electron-beam in accordance with the present invention will be described. Before the calibration, the length of the measurement part of the cross section of the measurement beam formed by the aperture is measured at a predetermined distance from the aperture by varying the state of a degree of the parallelism of electron-beam, and memorized as a part of the calibrating information (S41, 43).

Herein the calibrating information includes beam state information and the measured length. The beam state information indicates a state of a degree of the parallelism of the electron-beam, and the measured length is the length of the measurement part of the cross section of the measurement beam measured at a predetermined distance from the aperture under the state of a degree of the parallelism indicated the beam state information. In the calibrating information, the measured length is memorized in relation to the state of a degree of the parallelism of the electron-beam indicated the beam state information.

In the calibration, first, the length of the measurement part of the cross section of the measurement beam is measured at the predetermined distance from the slit (S45). The calibration of a degree of the parallelism is, then, performed on the basis of the length measured in step S45 and, in accordance with the calibrating information obtained in step S41 and S43, i.e. the adjustment of a degree of the parallelism is continued until the length measured in step S45 becomes equal to the memorized length in relation to the desirable state of a degree of the parallelism of the electron-beam (S47, S49). Hence, the adjustment of a degree of the parallelism of the electron-beam is achieved.

Memorizing the calibrating information once (S41, S43), it is not necessary to expose test patterns on the resist layer every time the parallelism adjustments are performed. The work and time required in the test pattern exposing can thus be saved. Moreover, the above-mentioned method allows the operation of the adjustment to be performed automatically.

Herein, the widths of the pattern of the images actually exposed on the resist layer 35 in a plurality of states of a degree of the parallelism of the electron-beam with the pattern which has a predetermined line width, is preferably used as the beam status information which indicates the state of a degree of the parallelism (i.e. focus) of the electron-beam. The desirable state of a degree of the parallelism of the electron-beam means the state in which the line width of the original pattern is equal to the line width of the pattern exposed on the resist layer, at the most appropriate dose of the irradiation of the electron. In such state, the pattern should be exposed at the same size.

Referring to the FIG. 6, the method of the calibration of a degree of the astigmatism of the electron-beam in accordance with the present invention will be described. Before calibration, the measurement part in the cross section of the measurement beam formed by the aperture, is measured at a predetermined distance from the aperture by varying the state of a degree of the astigmatism of electron-beam, and memorized as a part of the calibrating information (S51, 53).

Herein the calibrating information includes beam state information and the measured length. The beam state information indicates a state of a degree of the astigmatism of the electron-beam, and the measured length is the length of the measurement part of the cross section of the measurement beam measured at a predetermined distance from the aperture under the state of a degree of the astigmatism indicated the beam state information. In the calibrating information, the measured length is memorized in relation to the state of a degree of the astigmatism of the electron-beam indicated by the beam state information.

Herein, the beam state information is memorized in relation to each axis defined in FIG. 4 (e.g. the Y-axis and X-axis). The information in relation to Y-axis is memorized in relation to the measured length of the measurement part, which is measured in the Y1 or Y2 direction, the information in relation to X-axis is also memorized in relation to the measured length of the measurement part, which is measured in the X1 or X2 direction.

In the following step S55-S59, the adjustment relating to the Y-axis astigmatism is performed. The length of the measurement part in the cross section of the measurement beam is measured at the predetermined distance from the aperture (S55). Herein, the direction for measurement of said measurement part is oriented to either the Y1 or Y2 direction, in which said measured length is measured, which is memorized in relation to the state of a degree of the astigmatism of the electron-beam indicated by the beam state information in step S51. The calibration of a degree of the astigmatism is, then, performed on the basis of the length measured in step S55 and in accordance with the calibrating information obtained in step S51, 53, i.e. the adjustment of a degree of the astigmatism is continued until the length measured in step S55 becomes equal to the memorized length in relation to the desirable state of a degree of the astigmatism of the electron-beam (S57, S59). The adjustment relating to the X-axis astigmatism is also performed in the similar way of the adjustment relating to the Y-axis astigmatism in the following step S61-S65.

Herein, the widths of the pattern of the images actually exposed on the resist layer 35 in a plurality of states of a degree of the astigmatism of the electron-beam with the pattern which has a predetermined line widths in the Y1 (and/or Y2) and X1 (and/or X2) directions, is preferably used as the beam state information which indicates the state of a degree of the astigmatism of the electron-beam.

Moreover, a simpler method of the adjustment for astigmatism which does not use said calibrating information is provided in accordance with the present invention. Referring to the FIG. 7, the method of the adjustment of a degree of the astigmatism of the electron-beam in accordance with the present invention, for example in relation to Y-axis direction astigmatism, will be described. An aperture which has a predetermined length part is used in the adjustment of a degree of the astigmatism of the electron-beam in accordance with the present invention similarly to said method of the parallelism/astigmatism calibration. Then, the cross section of the electron-beam is formed by passed through the aperture and, hence, the electron-beam is formed into the measurement beam. A measurement part, corresponding to the predetermined length part of aperture is formed in the cross section of the measurement beam. The measurement part is formed such that the lengths of part can be measured in two orthogonal directions on the cross section of the beam (i.e. on a plane perpendicular to a beam axis of the electron-beam). Then, the lengths of the measurement part are measured at a predetermined distance from the aperture such that the measured lengths varies in the two orthogonal directions, in response to the variation of the state of a degree of the astigmatism of the electron-beam (S71, S73). For example the length measured in the first direction is referred to the length Y1, and the length measured in the second direction is referred to the length Y2. These length (the length Y1, Y2) are compared with each other (S75), and then the correction of the astigmatism relating to Y-axis is performed on the basis of the result of the comparison (S77). The adjustment of the astigmatism relating to X-axis is also performed by the similar way as the steps S71-S77. Hence, the adjustment of a degree of the astigmatism of the electron-beam is achieved.

Several types of aperture members or the forming means with the opening of several shapes indicated in FIG. 8A-8D can be used in the method of the adjustment of a degree of the astigmatism in accordance with the present invention. FIG. 8A shows the aperture member comprising four rectangle slits 81, 83, 85, 87 with the predetermined width in one direction, disposed perpendicularly each other. The aperture member indicated in FIG. 8A forms the measurement part in the Y1 direction with slit 89 and the measurement part in the Y2 direction with slit 91 respectively, from the electron-beam 3. FIG. 8B shows the aperture member comprising a slit 93 with the predetermined width in two orthogonal direction. The aperture member indicated in FIG. 8B forms the measurement part in the Y1 direction with the part with predetermined width 95 of the slit 93 and in the Y2 direction with the part with predetermined width 97 of the slit 93 respectively, from the electron-beam 3. The widths of openings of the slit 89 and 91 (and 95 and 97) may be formed by the same length such that the length Y1 and Y2 are generated by the same length. FIG. 8C shows the aperture member comprising a slit 99 with the predetermined width in one direction, wherein the aperture member in FIG. 8C is rotated as shown in FIG. 8D to form the measurement parts 101, 103 in two orthogonal direction.

The center of the aperture member 105 can be moved from the center of the electron-beam in response to the radius of the beam as shown in FIG. 9A. Herewith, the most appropriate length measurement can be performed in response to the radius of the beam. The center of the aperture member 105 is moved by a distance d1 to form the measurement part with the predetermined length part from a small electron-beam 3. Alternatively, the opening of the aperture member is formed in rectangular shape of which a width is fixed such that the measurement part formed on the cross section of the beam can be measured in its width over its length as shown in FIG. 9B.

As shown FIG. 9C, it is possible that the openings of the aperture member has parts 109, 111 with different line width. Preferably, the lengths memorized in relation to the states of the electron-beam contained in the calibrating information and the length which is measured when the calibration is performed must be measured at a same part of the aperture. Herewith the precision of the measurement of the state of the electron-beam can be improved. Moreover, the calibrating information also includes the information relating to the position where the measured lengths included were measured at the aperture.

Further, the average of a plurality of the measured lengths 113 can be used as the measured length as shown in FIG. 9D, in order to improve the precision of the measurement of the state of the electron-beam even if the aperture has parts 109, 111 with different width of the slit as shown in FIG. 9C.

The above-mentioned method can save work and time for adjusting the state of the electron-beam with the result that the exposing test pattern is made redundant. Moreover, the above-mentioned method allows the operation of the adjustment to be performed automatically. It should be noted that the predetermined width parts are preferably made as the part of openings of the aperture member which the electron-beam can pass through, and may be made as the part of the masks of aperture member which interrupt the electron-beam.

The measurement part is measured by a length measuring portion which preferably comprises an image sensor having a CCD (charge coupled device) photo acceptance unit. The length measuring portion with such configuration allows a plurality of the measurement performed concurrently in order to improve the precision of the measurement as above with simple configuration, and allows the measurements performed in the two orthogonal directions concurrently with simple configuration in the adjustment of a degree of the astigmatism.

In accordance with the present invention, a methods and devices for adjusting a degree of the parallelism and the astigmatism of the electron-beam of the electron-beam proximity exposure apparatus, which allow an automatic and quick adjustment, will be provided.

### BRIEF DESCRIPTION OF THE DRAWING

The above and other objects, features, and advantages of the present invention will be made more apparent from the following description of the preferred embodiments thereof with reference to the accompanying drawings, wherein:

FIG. 1 is a schematic diagram of a conventional electron-beam proximity exposure apparatus;

FIG. 2A is a side view of the non-parallel electron-beams;

FIG. 2B is a top view of the portions of the resist layer irradiated by the non-parallel electron-beams;

FIG. 3 is a top view of the portion of the resist layer irradiated by the beam has astigmatism;

FIG. 4 is a top view of the astigmatism correction coils;

FIG. 5 is a flowchart of the method for the parallelism adjustment in accordance with the present invention;

FIG. 6 is a flowchart of the method for the astigmatism adjustment in accordance with the present invention;

FIG. 7 is flowchart of another method for the astigmatism adjustment in accordance with the present invention;

FIG. 8A-8D are top views of the slits and the aperture members used in the method for the adjustment in accordance with the present invention;

FIG. 9A-9D are schematic diagrams of the usage of the slit used in the method for the adjustment in accordance with the present invention;

FIG. 10 is a schematic diagram of the electron-beam proximity exposure apparatus as similar to the apparatus of FIG. 1, which is provided with the parallelism/astigmatism adjustment device.

FIG. 11A is an outline drawing of the detector placed on the XY-stage shown in FIG. 10;

FIG. 11B is a schematic diagram of the detector placed on the XY-stage shown in FIG. 10;

FIG. 12A is a top view of the aperture member provided on the top surface of the detector shown in FIGS. 11A and 11B;

FIG. 12B is a top view of the image of the measurement beam formed on the fluorescent plane shown in FIGS. 11A and 11B;

FIG. 12C is the profile of the illumination intensity of the measurement part of the image of FIG. 12B;

FIG. 13A-13B are tables of the example of the parallelism calibrating information;

FIG. 14 is a flowchart of the method for the parallelism adjustment of the device for the adjustment shown in FIG. 10;

FIG. 15 is a schematic diagram of a preferred example of the shape of the measurement part of the measurement beam, which is formed on the fluorescent plane;

FIG. 16A is a schematic diagram of an alternative detector to the detector shown in FIG. 10;

FIG. 16B is a schematic diagram of the Faraday cup used in the detector shown in FIG. 16A.

FIG. 17A is a schematic diagram of the method of measuring in length with the detector shown in FIG. 16A;

FIG. 17B is a graphical representation of the variation of an amount of incident electrons as function of the position of the Faraday cup.

FIG. 18 is a table of the example of the astigmatism calibrating information;

FIG. 19 is a flowchart of the method for the astigmatism adjustment of the device for the adjustment shown in FIG. 10;

FIG. 20A is a schematic diagram of the aperture member used in the Y-axis astigmatism adjustment in accordance with the method of FIG. 19;

FIG. 20B is a schematic diagram of the direction in which the length is measured in the Y-axis astigmatism adjustment in accordance with the method of FIG. 19;

FIG. 21A is a schematic diagram of the aperture member used in the X-axis astigmatism adjustment in accordance with the method of FIG. 19;

FIG. 21B is a schematic diagram of the direction in which the length is measured in the X-axis astigmatism adjustment in accordance with the method of FIG. 19;

FIG. 21C is a top view of the aperture member having eight slits.

FIG. 22 is a schematic diagram of the second embodiment of the device for the parallelism/astigmatism adjustment in accordance with the present invention, and the electron-beam proximity exposure apparatus of FIG. 1;

FIG. 23 is a flowchart of the method for the astigmatism adjustment of the device for the adjustment shown in FIG. 22;

FIG. 24A is a table of examples of the lengths measured along the Y-axis;

FIG. 24B is a table of examples of the lengths measured along the X-axis;

FIG. 25 is a schematic diagram of the third embodiment of the device for the parallelism/astigmatism adjustment in accordance with the present invention, and the electron-beam proximity exposure apparatus of FIG. 1;

FIG. 26 is a table of examples of the astigmatism calibrating information used by the device for the parallelism/astigmatism adjustment of FIG. 25; and

FIG. 27 is a flowchart of the method for the astigmatism adjustment of the device for the adjustment shown in FIG. 25.

### DESCRIPTION OF THE PREFERRED EMBODIMENTS

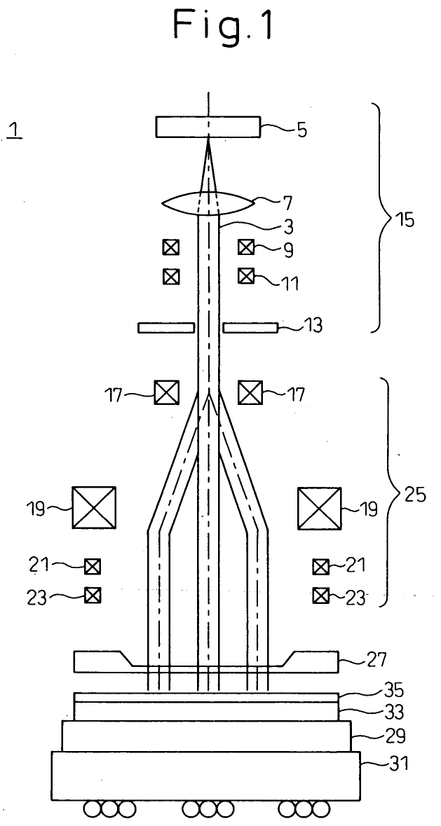

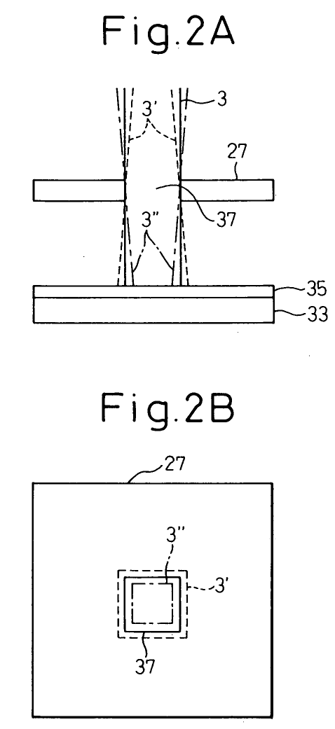

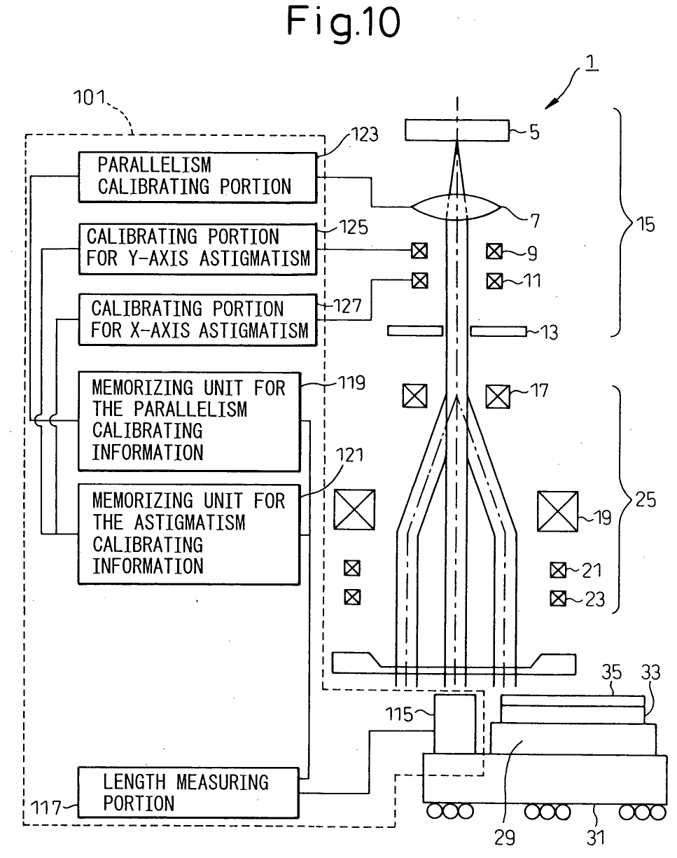

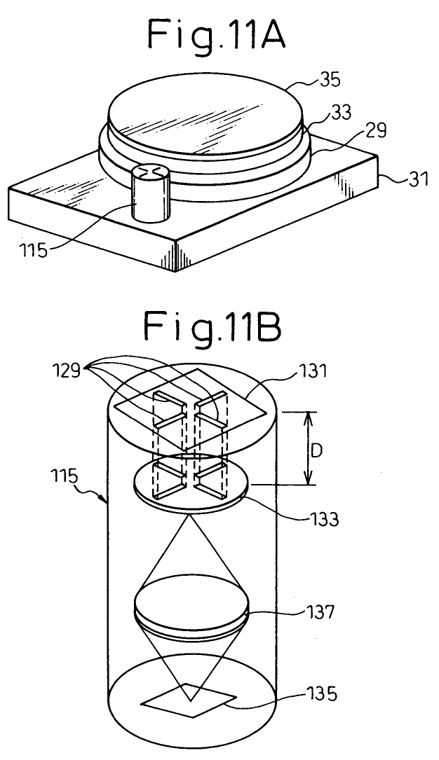

FIG. 10 is a schematic diagram of the electron-beam proximity exposure apparatus 1 similar to the apparatus of FIG. 1, which is provided with the parallelism/astigmatism adjustment device 101 in accordance with the present invention. As above, with reference to FIG. 1, the electron-beam proximity exposure apparatus 1 mainly comprises an electron gun 15 including an electron source 5 which generates a beam of electron 3, a lens 7, a Y-axis astigmatism correction coil 9 and a X-axis astigmatism correction coil 11, and a beam limiting aperture 13, a scanning means 25 including main sets 17, 19 of deflectors and sub sets 21, 23 of deflector, which scans the electron-beam horizontally, a mask for exposing 27, an electrostatic chuck 29, and an XY-stage 31.

The adjustment device 101 comprises the length measuring portion 117 which comprises the detector 115 placed on the XY-stage 31, the memorizing unit for the parallelism calibrating information 119 memorizing the parallelism calibrating information which contains the lengths measured by the length measuring portion 117 and the state of a degree of the parallelism (i.e. the focus) of the electron-beam 3 in relation to each other, the memorizing unit for the astigmatism calibrating information 121 memorizing the astigmatism calibrating information which contains the lengths measured by the length measuring portion 117 and the state of a degree of the astigmatism of the electron-beam 3 along Y-axis and X-axis, in relation each other, the parallelism calibrating portion 123 which calibrates a degree of the parallelism of the electron-beam 3 by controlling the lens 7 on the basis of the lengths measured by the length measuring portion 117, and in accordance with the parallelism calibrating information memorized in the memorizing unit for the parallelism calibrating information 119, the calibrating portion for the Y-axis astigmatism 125 which calibrates a degree of the Y-axis astigmatism by controlling the Y-axis astigmatism correction coil 9 on the basis of the lengths measured by the length measuring portion 117, and in accordance with the astigmatism calibrating information memorized in the memorizing unit for the astigmatism calibrating information 121, the calibrating portion for the X-axis astigmatism 127 which calibrates a degree of the X-axis astigmatism by controlling the X-axis astigmatism correction coil 11 on the basis of the lengths measured by the length measuring portion 117 and in accordance with the astigmatism calibrating information memorized in the memorizing unit for the astigmatism calibrating information 121.

FIG. 11A is an outline drawing of the detector 115 placed on the XY-stage 31, and FIG. 11B is a schematic diagram of the detector 115. The detector 115 has the aperture member for forming an electron-beam 131 at its top face, the aperture member 131 comprises the slits 129 as apertures. The opening of each slit 129 has a part or parts of which the size of width and/or length is predetermined. When the electron-beam 3 passes through the slits 129, the beam is formed into beams having a cross section which has a part or parts with width and/or length corresponding to the predetermined size of width and/or length of the slits 129 (hereinafter, the beam formed by the slit 129 will be referred to the measurement beam).

Inside of the detector 115, it comprises the fluorescent plane 133 which emits light when the measurement beams impinges thereupon, the image sensor 135 detects the images on the fluorescent plane 133, optical system (lens) 137 which forming image on the image sensor 135 from the image generated on the fluorescent plane 133. The measurement beam makes the image which has part(s) corresponding to the parts of which predetermined size of width and/or length of the slits 129. Hereinafter, the part(s) on the cross section of the measurement beams and the part(s) of the image of the measurement beams which is formed on the fluorescent plane 133, corresponding to the predetermined size of width and/or length of the slit 129 will be referred the measurement part(s).

The fluorescent plane 133 is disposed at predetermined distance D from the slits 129, such that the length of the measurement part(s) of the images formed on the fluorescent plane 133 will vary with the variation of the state of a degree of the parallelism of the electron-beam 3 passing through the slits 129. Preferably, a CCD (charge coupled device) photo acceptance unit is used as the image sensor 135.

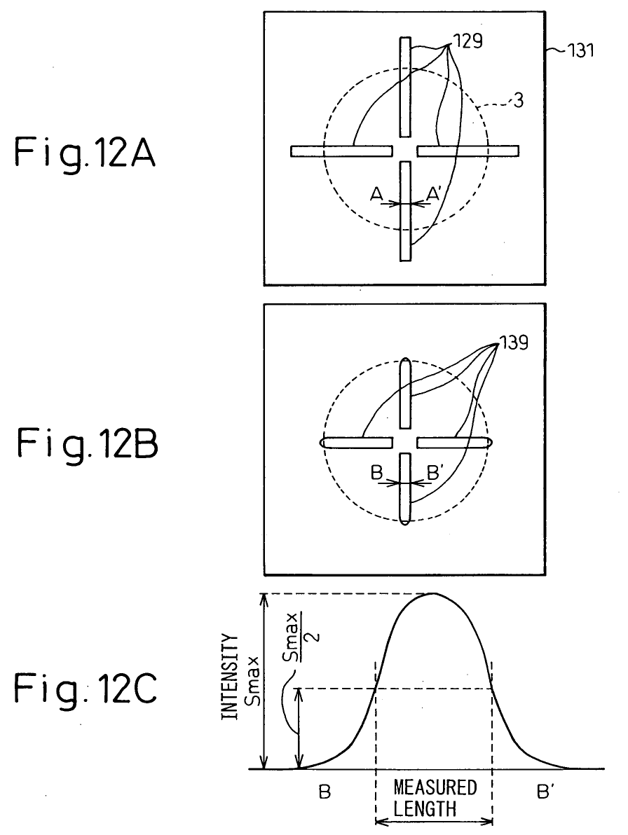

Referring now to FIG. 12A-12C, the method for forming the shape of the cross section of the beam 3 and the method for measuring the length of the measurement part(s) of the beam formed by the aperture member will be described. FIG. 12A is a top view of the aperture member 131 provided on the top surface of the detector 115. The slits 129 are formed on the aperture member 131 as rectangular openings, which have a constant line width, and the section A-A′ of the opening is used as a predetermined length part which has a predetermined length. The electron-beam 3 irradiated on the aperture member 131 is formed by the slits 129 into the measurement beams, and generates the images of the cross section of the measurement beams 139 on the fluorescent plane 133 as shown in FIG. 12B. The images 139 have the measurement part(s) (the section B-B′) corresponding to the predetermined length part(s) (the section A-A′) of the slits 129. The images 139 on the fluorescent plane 133 are detected by the image sensor 135 and a one-dimensional illumination intensity profile of vicinity of the section B-B′ shown in FIG. 12C is created. The length measuring portion 117 calculates the full width at half maximum (i.e. the distance between the points at where the illumination intensity is half value Smax/2 of maximum value Smax) of the illumination intensity profile. The measured length can be obtained.

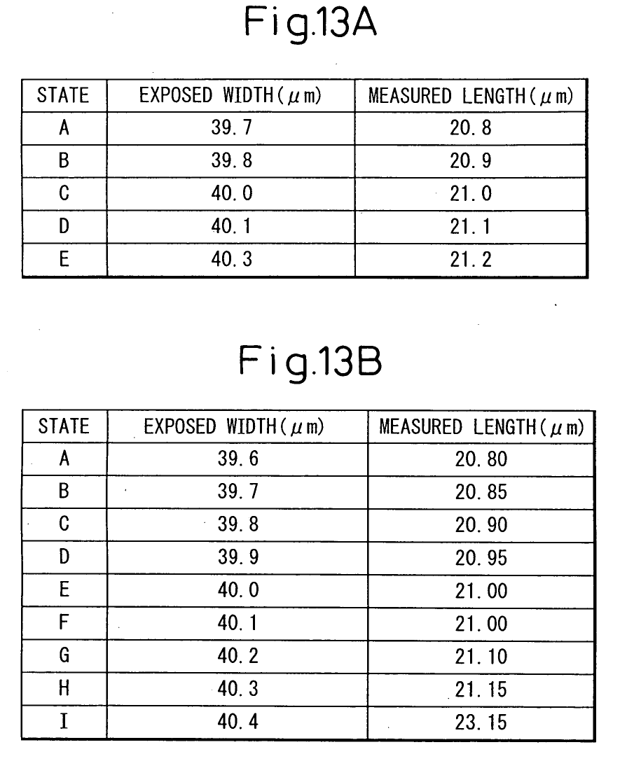

FIGS. 13A and 13B are table of the examples of the parallelism calibrating information memorized in the memorizing unit for the parallelism calibrating information 119. In the case of the parallelism calibrating information shown in FIGS. 13A and 13B, for example, the beam state information which indicates the states of a degree of the parallelism (i.e. the focus) of the electron-beam is obtained in the following way. At first, a predetermined pattern which has a predetermined line width (ex. 40 μm) is exposed on the resist layer 35 at a plurality of parallelism states (ex. the parallelism states A-E in the case shown in FIG. 13A, and parallelism states A-I in the case shown in FIG. 13B). Next, the width of the exposed pattern on the resist layer 35 is measured by the length measuring means, such as a scanning with electron microscope (SEM). Then, the measured width is obtained as the beam state information which indicates the state of a degree of the parallelism of the electron-beam. The parallelism calibrating information shown in FIGS. 13A and 13B also includes each of the lengths measured by the length measuring portion 117 at each of said parallelism states in relation to each of the line width of the exposed pattern. So each of the lengths measured by the length measuring portion 117 corresponds to each of the measured widths of the exposed pattern which indicate each the state of a degree of the parallelism of the electron-beam. In the case of the parallelism calibrating information shown in FIGS. 13A and 13B, for example, the line width of each the slits 129 of the aperture member 131 is 20 μm. Preferably, the parallelism calibrating information includes such data by a minimum adjustable step over all or a part of the adjustable range of lens 7.

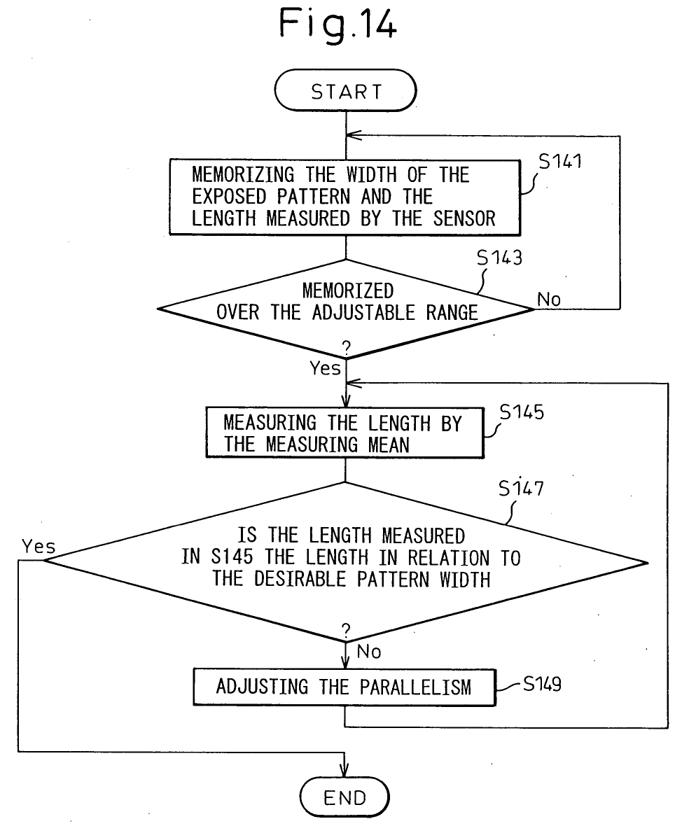

Referring now to FIGS. 13A, 13B, and 14, a method for the parallelism adjustment in accordance with the prevent invention will be described. FIG. 14 is a flowchart of the method for the parallelism adjustment in accordance with the prevent invention.

Before the parallelism adjustment, the test pattern is exposed on the resist layer 35 in a plurality of states as the state of a degree of the parallelism of the electron-beam is varied over all or a part of the adjustable range of lens 7. Then, the line widths of the patterns exposed on the resist layer 35 are measured in length and the measured length measured by the length measuring portion 117 is measured in each of the state of a degree of the parallelism and memorized in relation to each of the beam status information indicates the state of a degree of the parallelism (S141, S143).

In the parallelism adjustment, a measurement part or measurement parts of a cross section of the measurement beam which is formed from the electron-beam 3 is (are) measured by the length measuring portion 117, at first (S145). Herein, the measured length is 20.8 μm, for example. The parallelism calibrating portion 123, then, determines whether the measured length (ex. 20.8 μm) is the same as the measured length (ex. 21.0 μm) memorized in the memorizing unit for the parallelism calibrating information 119, which is corresponding to target line width of the pattern (ex. 40.0 μm) or not (S147). The parallelism calibrating portion 123 adjusts a degree of the parallelism of the beam 3 by controlling lens 7 until the measured length reaches the memorized length corresponding to target line width of the pattern (ex. 21.0 μm). Thus the adjustment of a degree of the parallelism of the electron-beam is achieved.

It should be noted that there is no need that the length (ex. 21.0 μm) should be memorized in the memorizing unit for the parallelism calibrating information 119 in relation to the target width of the pattern (ex. 40.0 μm) to be the same as the real line width of the slits 129 (ex. 20.0 μm). In actually, the cross section of the measurement beam enlarges after being formed by the aperture member 131 because the fluorescent plane 133 is at predetermined distance D from the aperture member 131, as shown in FIG. 13B, such that the length of the measurement part(s) of the image on the fluorescent plane 133 should be varied in response to the parallelisms of the electron-beam 3, and the electron-beam 3 is affected by Coulombic effect (space charge effect). It is possible that the measured length of the image generated on the fluorescent plane 133 is not the same size as the predetermined width of the slit 129 even if the state of a degree of the parallelism of the electron-beam 3 is desirable. In the present invention, the exact parallelism adjustment is achieved by memorizing the target width of the exposed pattern and the measured length of the measurement part(s) of the image on the fluorescent plane 133 in relation to each other, and calibrating in accordance with these memorized lengths.

Similarly, it should to be noted that the exact parallelism adjustment is achieved even if the length of the images formed on the image sensor 135 is not the same size as the length of the images generated on the fluorescent plane 133.

Referring to FIG. 13B, the parallelism calibrating information which is obtained by varying the state of a degree of the parallelism by a predetermined adjustable step will be described. As shown in FIG. 13B, the measured length (21.0 μm) corresponds to both the target width of the pattern exposed at the desirable state of a degree of the parallelism E (40.0 μm) and the width of the pattern exposed at the state of a degree of the parallelism F which is not desirable (40.1 μm). In such case, the parallelism calibrating portion 123 processes as described below.

If such measured length (ex. 21.0 μm) is measured after the parallelism adjustment performed in step at least once (S149), the parallelism calibrating portion 123 determines whether the current state of a degree of the parallelism reaches the desirable state on the basis of the direction of the parallelism adjustment ever done. That is to say, for example in the case of FIG. 13B, the parallelism calibrating portion 123 determines that the current parallelism state reaches the desirable parallelism state E, when the variation of the measured length in the previous adjustment is directed toward the direction in which the measured length becomes lager, or the previous measured length is smaller than the current measured length. Contrarily, the parallelism calibrating portion 123 determines that the current parallelism state reaches the other parallelism state (ex. the state F), when the variation of the measured length in the previous adjustment is directed toward the direction in which the measured length becomes smaller, or the previous measured length is larger than the current measured length.

In the case wherein the direction of the parallelism adjustment which is performed before, cannot be used in the above-mentioned determination (for example said measured length (21.0 μm) is the length measured in the first measurement), the parallelism calibrating portion 123 controls the lens 7 to vary the parallelism state toward either of directions of the parallelism adjustment. For example, in the case of FIG. 13B, the parallelism calibrating portion 123 controls the lens 7 toward the direction in which the measured length becomes smaller until the measured length reduces to the other memorized length (ex. 20.95 μm). Thus the parallelism calibrating portion 123 can see the current parallelism state (ex. the state D), and proceed in the above-mentioned way.

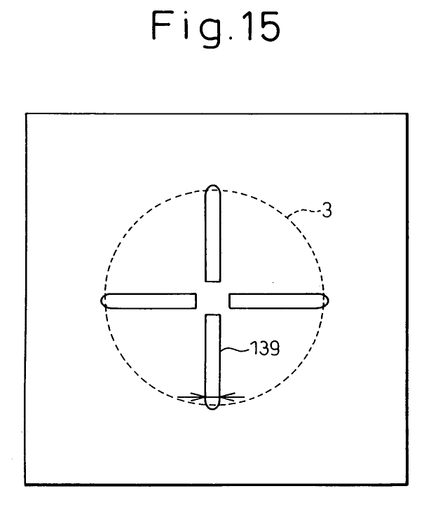

When the electron-beam 3 is the non-parallel beam or the beam has astigmatism, the orbits of the electron in the electron-beam 3 will tilt. The gradient of the orbits of the electron at the circumferential part is greater the gradient at the center of the beam. Thus, in order to improve the precision of the adjustment, the line width of cross section of beam formed from the circumferential part of the electron-beam 3 may be used as the measurement part(s) preferably, as shown in FIG. 15.

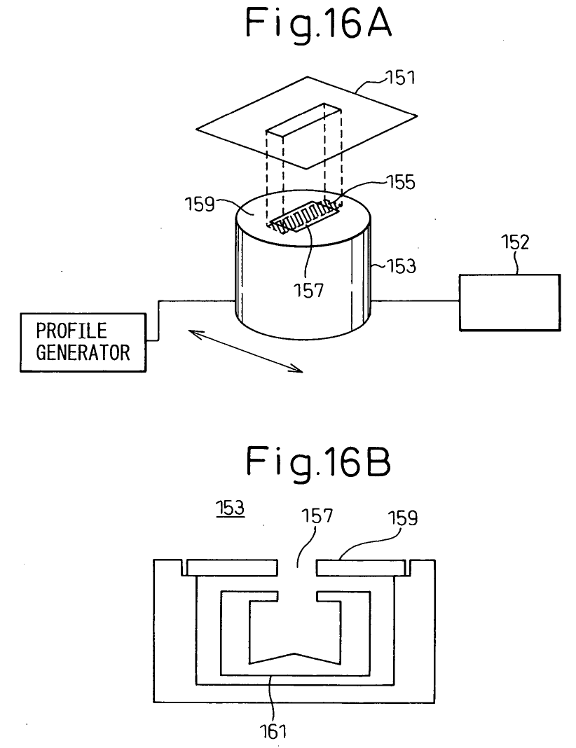

Also, the alternative detector which comprises the rectangle aperture member 151 which has an aperture, Faraday cup with knife-edge 153, a moving portion 152 moving the Faraday cup with a knife-edge in a plane perpendicular to a beam axis of the electron-beam 3, and profile generator 154 which generates an electron-beam intensity profile at the measurement part of the cross section of the measurement beam on the basis of the output signal of the Faraday cup with a knife-edge 153 as shown in FIG. 16A can be used instead of or in addition to said detector with image sensor 135 as above. The electron-beam is formed into the shape indicated by the hatched range 155 in FIG. 16A by the aperture of the forming means 151. The Faraday cup with knife-edge 153 can be moved by the moving portion 152 toward the direction indicated by the arrow in FIG. 16A. The Faraday cup with knife-edge 153 comprises the aperture 159 having the rectangle electron acceptance openings 157, and the electron detector 161 as shown in FIG. 16B.

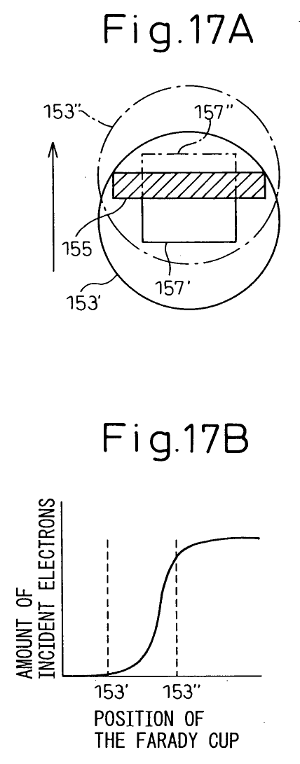

Referring to FIG. 17A-17B, the method of measuring the length of the measurement part(s) of the cross section of the electron-beam will be described. As shown in FIG. 17A, the rectangle electron-beam 155 formed by the rectangle aperture of the forming means 151 is used as the measurement beam. The rectangle electron-beam 155 begins to enter into the electron acceptance openings 157 when the Faraday cup is positioned near the position 153′, and wholly enters into the electron acceptance openings 157 when the Faraday cup is positioned at the position 153″. Herewith, an amount of the electrons which enter into the openings 157 is detected by the electron detector 161, as the Faraday cup is moved from the position 153′ to the position 153″. FIG. 17B shows the relation between the position of the Faraday cup 153 and amount of the incident electron. Then, the profile generator makes the profile similar to that shown in FIG. 12C by differentiating the function indicated by the graph shown in FIG. 17B, and the measuring of the measurement beam can be achieved by measuring the full width at half maximum of the profile.

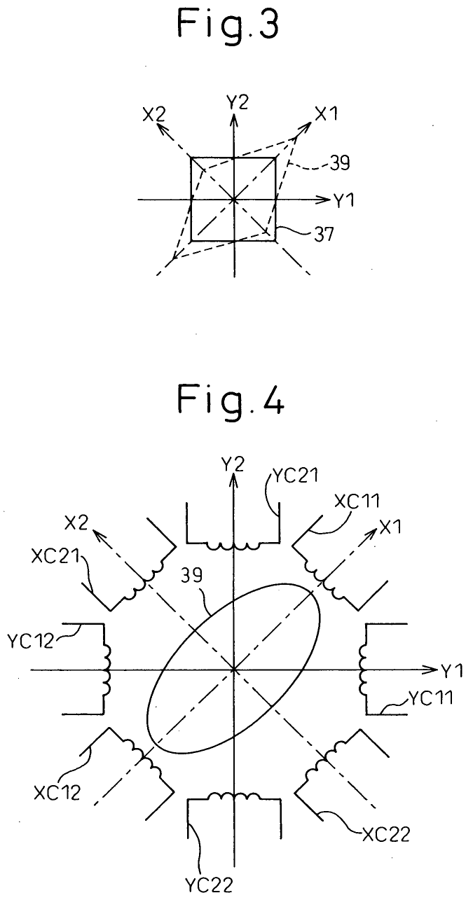

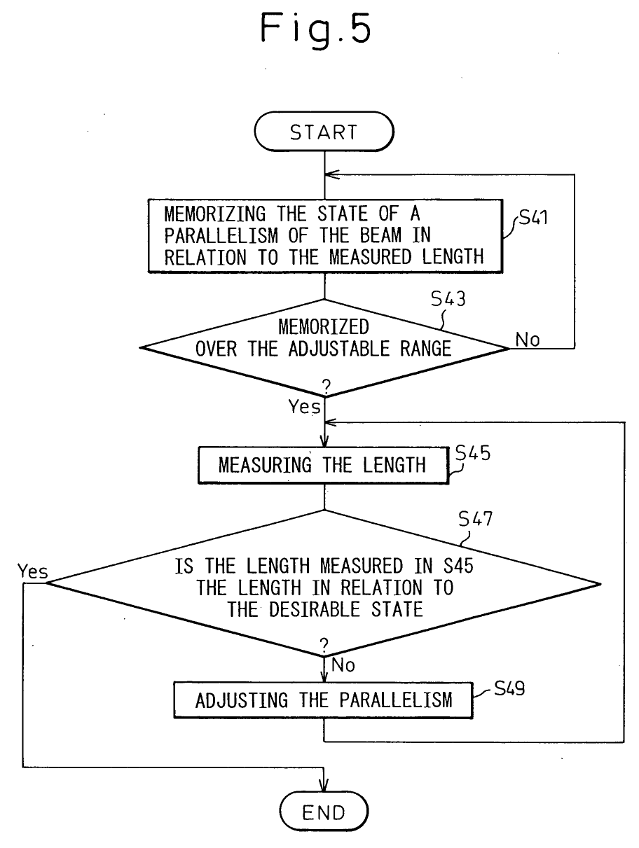

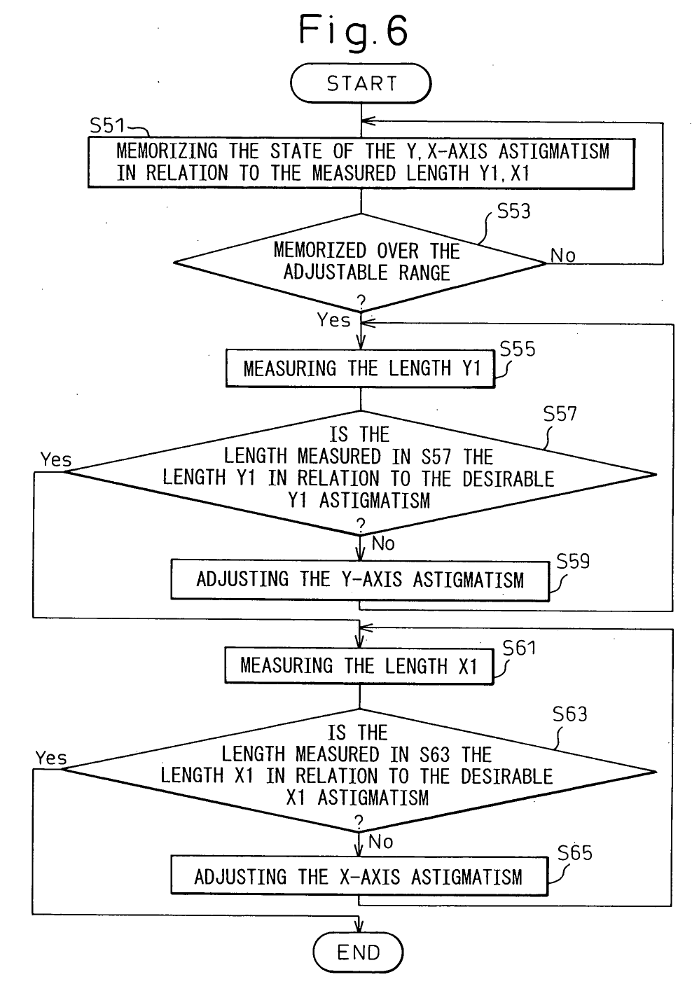

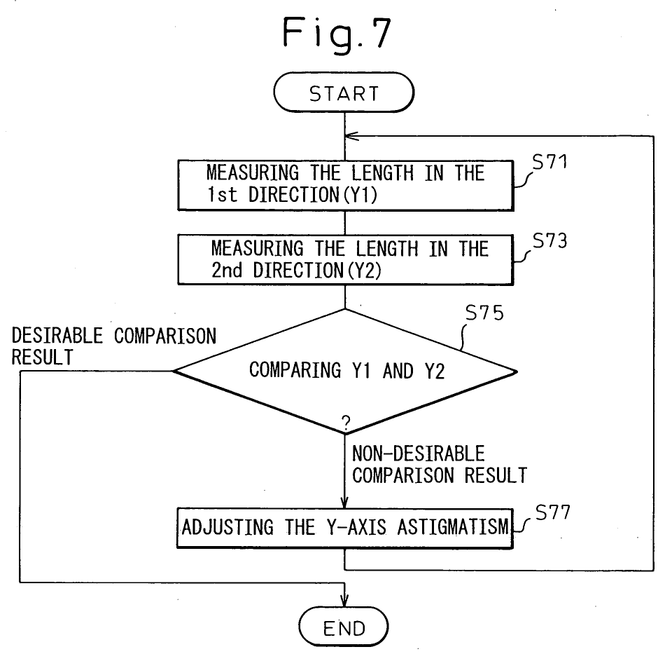

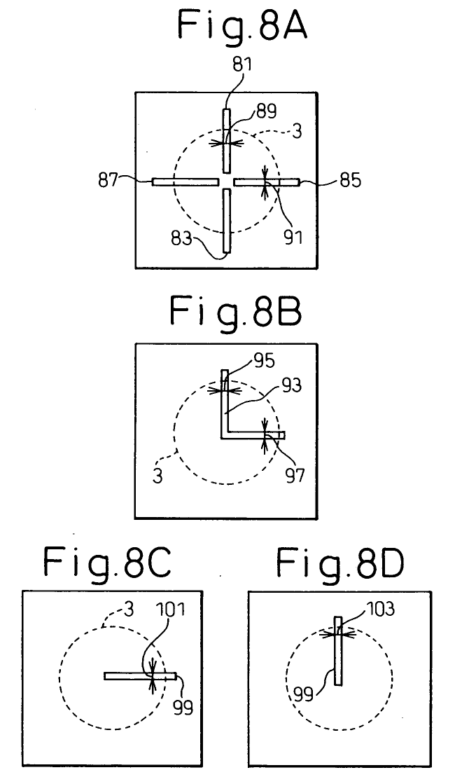

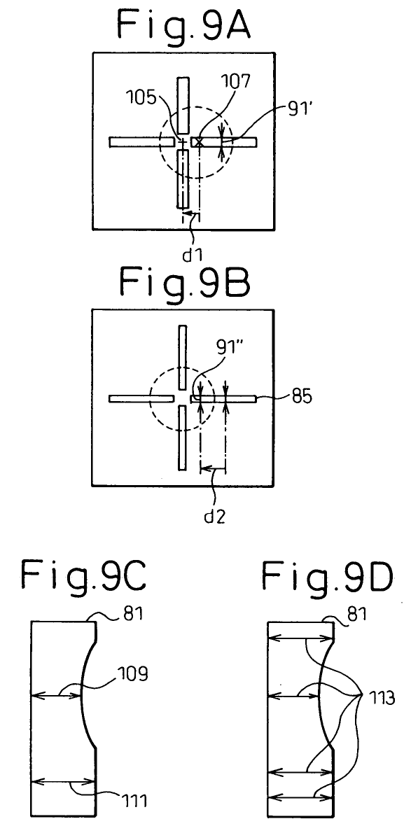

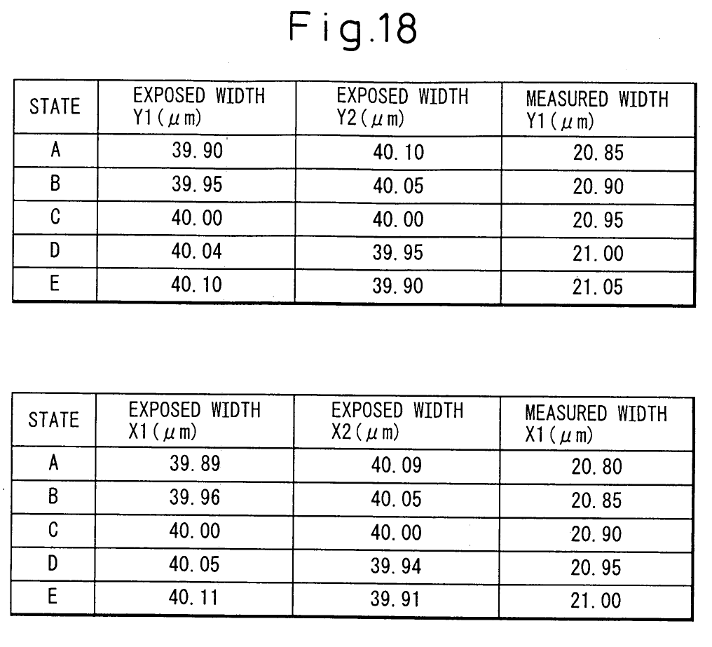

Then, the methods of adjusting the state of a degree of the astigmatism in accordance with the present invention will be described. FIG. 18 is a table of the example of the astigmatism calibrating information memorized in the memorizing unit for the astigmatism calibrating information 121. In the case of the astigmatism calibrating information shown in FIG. 18, for example, the information which indicates the state of a degree of the astigmatism of the electron-beam is obtained in the following way. At first, a predetermined pattern which has a predetermined line width (ex. 40 μm) in the direction Y1, Y2, X1, and X2 shown in FIG. 3. and FIG. 4, is exposed on the resist layer 35 in a plurality of astigmatism states (ex. the astigmatism states A-E in the case shown in FIG. 18). Next, each of the line widths of the exposed pattern on the resist layer 35 is measured, and the measured widths are memorized as the beam state information which indicates a degree of the astigmatism of the electron-beam. The astigmatism calibrating information shown in FIG. 18 also contains each of the lengths in the direction Y1 (and/or Y2) and X1 (and/or X2) measured by the length measuring portion 117 corresponding to each of said states, such that each of the lengths measured by the length measuring portion 117 is in relation to each of the measured widths of the exposed pattern which indicates each of the states of a degree of the astigmatism of the electron-beam. Preferably, the astigmatism calibrating information includes such data by minimum adjustable step over all or a part of the adjustable range of Y-axis astigmatism correction coil 9 and X-axis astigmatism correction coil 11.

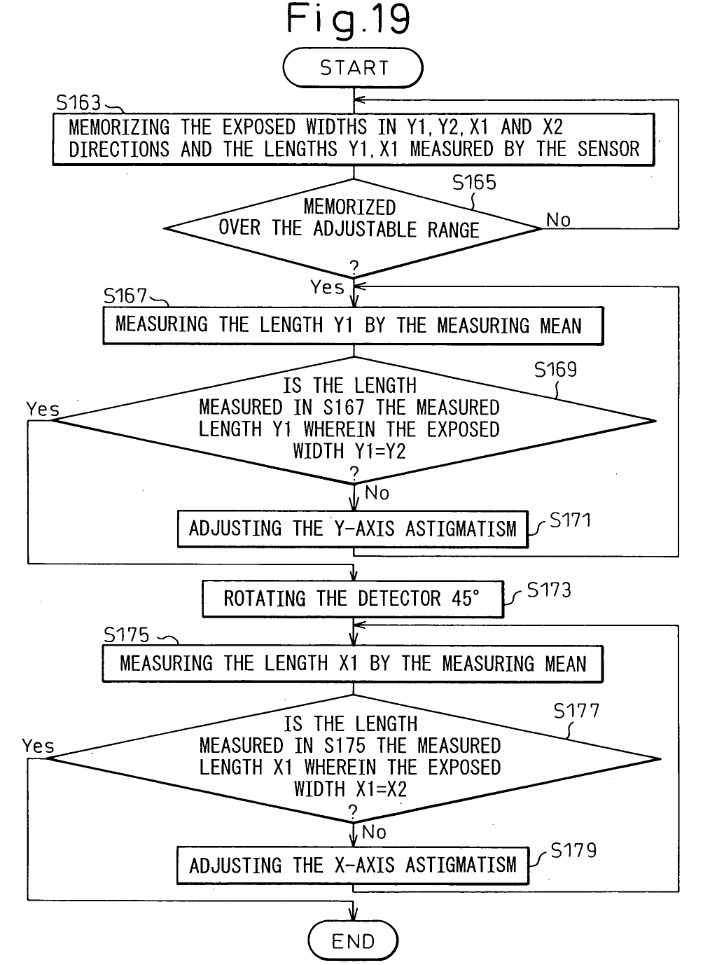

FIG. 19 is a flowchart of the method for the astigmatism adjustment in accordance with the present invention. Before the astigmatism adjustment, the test patterns, having widths in the Y1, Y2, X1 and X2 directions are exposed on the resist layer 35 in a plurality of states as the state of a degree of the astigmatism of the electron-beam are varied over all or a part of the adjustable range of astigmatism correction coil 9, 11. Then, the each of line widths of the exposed patterns is measured in the Y1, Y2, X1 and X2 directions and the each of measured lengths measured length in the direction Y1, Y2, X1 and X2 measured by the length measuring portion 117 are measured at each of states of a degree of the astigmatism and memorized in relation to each other (S163, S165).

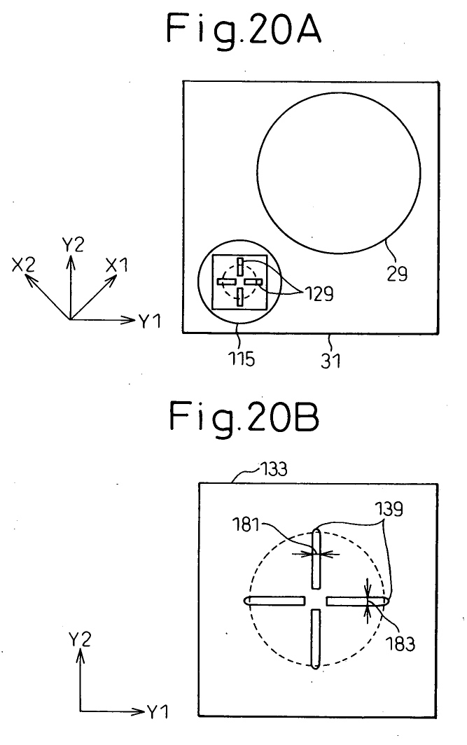

In the calibration of a degree of Y-axis astigmatism, the detector 115 (or only the aperture member 131) is controlled such that the direction of a width of at least one of the slits 129 is oriented to the adjustable direction of at least one of the Y-axis astigmatism correction coil 9 (i.e. the Y1 or Y2 direction) as shown in FIG. 20A. Then, a measurement part or measurement parts 181 of the cross section of the measurement beam, which is formed by a slit 129 to have the measurement part(s) in Y1 (or Y2) direction, is measured by the length measuring portion 117 (S167) as shown in FIG. 20B. The method of the measuring the length of the measurement part(s) is similar as the above-mentioned method of measuring the length by the length measuring portion 117 having the detector 115 in the method of the parallelism adjustment. For example, the measured length is 20.85 μm, so the current state is the state A indicated by the table in FIG. 18. The calibrating portion for the Y-axis astigmatism 125, then, determines whether the measured length (ex. 20.85 μm) is the same as the measured length (ex. 20.95 μm) memorized in the memorizing unit for the astigmatism calibrating information 121, which is in relation to the target state of a degree of the astigmatism, wherein the desirable exposing will be performed (S169). Herein the term “desirable exposing” means the exposing in which the line width in the Y1 direction of the exposed patterns is same as the line width in the Y2 direction of that one (ex. 40.0 μm). The calibrating portion for Y-axis astigmatism 125 adjusts a degree of the Y-axis astigmatism of the beam 3 by controlling the Y-axis astigmatism correction coil 9 until the measured length reaches the memorized length (ex. 20.95 μm) corresponding to target line width of the pattern (S171).

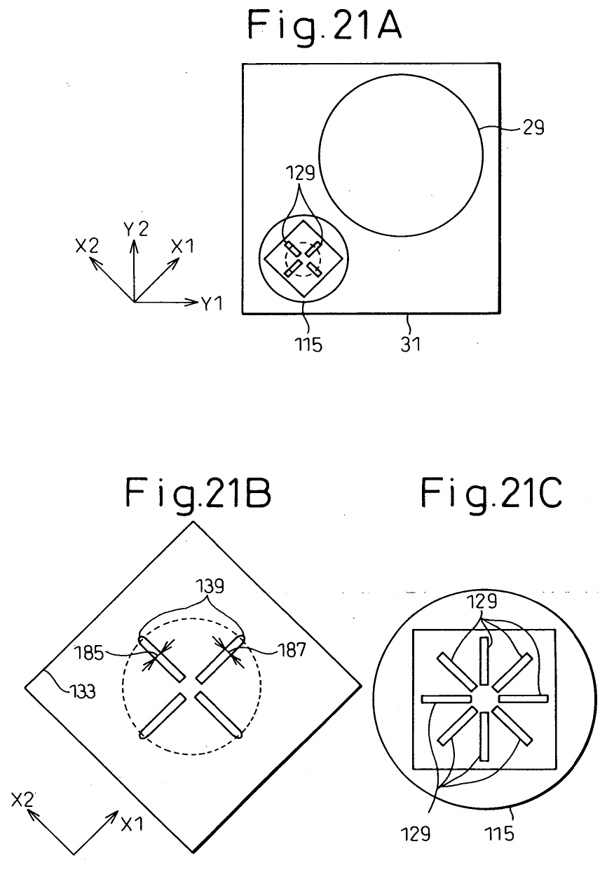

In the calibration of a degree of X-axis astigmatism, the detector 115 (or only the aperture member 131) is controlled, for example it is rotated 45-degree, such that the direction of the width of at least one of the slits 129 is oriented to at least one of the adjustable direction of the X-axis astigmatism correction coil 11 (i.e. the direction X1 or X2 direction) as shown in FIG. 21A (S173). Then, a measurement part or measurement parts 185 of the cross section of the measurement beam, which is formed by a slit 129 to have the measurement part(s) in the X1 (or X2) direction, is measured by the length measuring portion 117 (S175) as shown in FIG. 21B. The method of the measuring the length of the measurement part(s) is similar to the above-mentioned method of measuring the length by the length measuring portion 117 having the detector 115 in the method of the parallelism adjustment. The calibrating portion for the X-axis astigmatism 127, then, determines whether the measured length is the same as the measured length memorized in the memorizing unit for the astigmatism calibrating information 121, which is related to with the target state of a degree of the astigmatism, wherein the desirable exposing in which the width in the X1 direction of the exposed patterns is same as the width in the X2 direction of that one, will be performed (S177). The calibrating portion for the X-axis astigmatism 127 adjusts a degree of the X-axis astigmatism of the beam 3 by controlling the X-axis astigmatism correction coil 11 until the measured length reaches the memorized length corresponding to target width of the pattern (S179). Thus, the calibration of a degree of the astigmatism of the electron-beam is achieved by the steps S163-S179.

In the method described above, the detector 115 having the aperture member with slits 129 shown in FIG. 21C may be used. The detector 115 has an aperture member having eight slits 129, wherein each of the slits is oriented to each of the adjustable direction of Y-axis astigmatism correction coil 9 and X-axis astigmatism correction coil 11 respectively, instead of its own rotation in the method of the X-axis astigmatism calibration as shown in FIG. 21A.

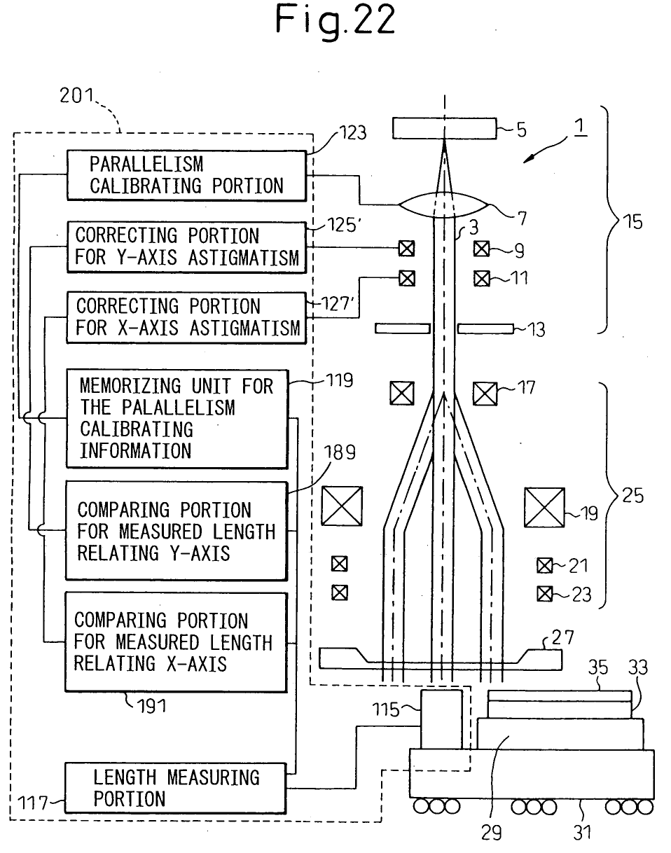

FIG. 22 is a schematic diagram of the electron-beam proximity exposure apparatus 1 similar to the apparatus of FIG. 1, which is provided with a simpler astigmatism adjustment device 201, in accordance with the present invention, than the adjustment device 101 in FIG. 10. The adjustment device 201 comprises the comparing portion for measured lengths relating Y-axis 189 which compares the measured length of the measurement part(s) in the Y1 and Y2 direction on the cross section of the beam 3, and the comparing portion for the comparing measured lengths relating X-axis 191 which compares the measured length of the measurement part(s) in the X1 and X2 direction on the cross section of the beam 3, instead of the memorizing unit for the astigmatism calibrating information 121, in order to simplify the method for the astigmatism adjustment used in the adjustment device 101 in FIG. 10. The correcting portion for the Y-axis astigmatism 125′ controls Y-axis astigmatism correction coil 9 on the basis of comparison by the comparing portion for the Y-axis 189. The correcting portion for the X-axis astigmatism 127 controls X-axis astigmatism correction coil 11 on the basis of comparison by the comparing mean for the X-axis 191.

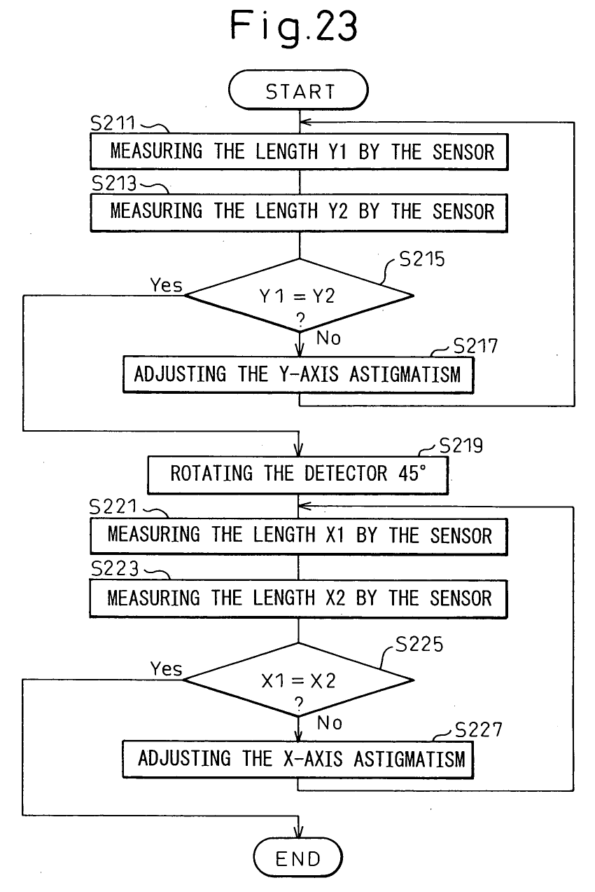

Referring to FIG. 23, the method of astigmatism adjustment in accordance with present invention will be described. FIG. 23 is a flowchart of the method for the astigmatism adjustment in accordance with present invention. The detector 115 (or only the aperture member 131) is controlled such that the directions of the widths of the slits 129 of the aperture member 131 are oriented to the adjustable directions of the Y-axis astigmatism correction coil 9 (i.e. the Y1 and Y2 direction) as shown in FIG. 20A. The aperture member comprises four rectangle slits disposed perpendicularly each other, as shown in FIG. 12A, wherein each of slits 129 having a predetermined line width in one direction, are used as slits 129. For the simplicity, the line widths of all slits 129 are identical.

The lengths of measurement part in the Y1 direction and Y2 direction 181, 183 of the image 129 of the cross section of the measurement beam generated on the fluorescent plane 133 in the detector 115 are measured respectively (S211, S213). The measurement of the lengths is performed by the method similar as the method of measuring the length by the length measuring portion 117 comprising the detector 115 in the above-mentioned method of parallelism adjustment.

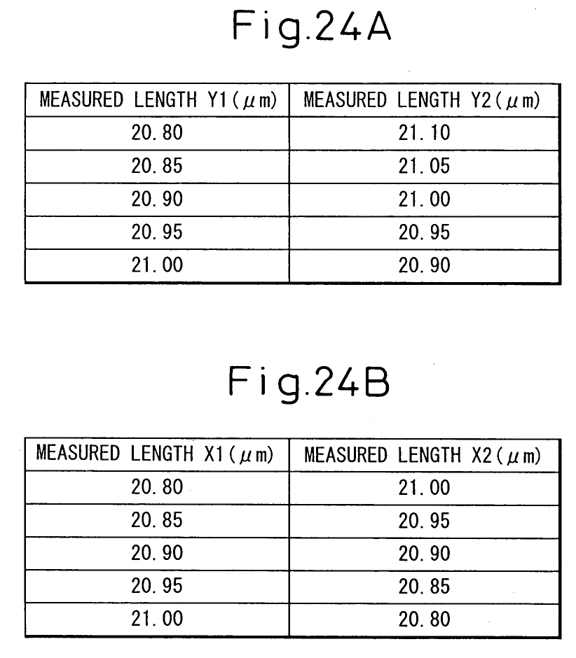

The comparing portion for the Y-axis 189 determines whether the measured length in the Y1 direction is equal to the measured length in the Y2 direction or not (S215). The correcting portion for the Y-axis astigmatism 125′ corrects (adjusts) a degree of the Y-axis astigmatism of the beam 3 by controlling Y-axis astigmatism correction coil 9 until these two measured lengths become equal to each other (S217). For example, if the measured lengths in the Y1 and the Y2 directions are measured as shown FIG. 24A, the comparing portion for the Y-axis 189 and the correcting portion for the Y-axis astigmatism 125′ corrects a degree of the astigmatism until the two measured lengths in both Y1 and Y2 direction become the length 20.95 μm.

Then, the detector 115 (or only the aperture member 131) is controlled and, for example it is rotated 45-degrees, such that the directions of the widths of the slits 129 are oriented to the adjustable directions of the X-axis astigmatism correction coil 11 (i.e. direction X1 and X2), as shown in FIG. 21A (S219). The lengths of measurement parts in the X1 direction and the X2 direction 185, 187 of the image 129 of the measurement beam generated on the fluorescent plane 133 in the detector 115 are measured respectively (S221, S223). The comparing portion for the X-axis 191 determines whether the measured length in the X1 direction is equal to the measured length in the X2 direction or not (S225). The correcting portion for the X-axis astigmatism 127′ corrects (adjusts) a degree of the X-axis astigmatism of the beam 3 by controlling X-axis astigmatism correction coil 11 until these two measured length become equal to each other (S227). For example, if the measured lengths in the X1 and the X2 directions are measured as shown FIG. 24B, the comparing portion for the X-axis 191 and the correcting portion the X-axis astigmatism 127′ corrects a degree of astigmatism until the two measured lengths in both X1 and X2 direction become the length 20.90 μm. Thus, the correcting of a degree of the astigmatism of the electron-beam is achieved. In the method described above, the detector 115 having slits 129 shown in FIG. 21C may be used instead of rotating the detector 115 as shown in FIG. 21A.

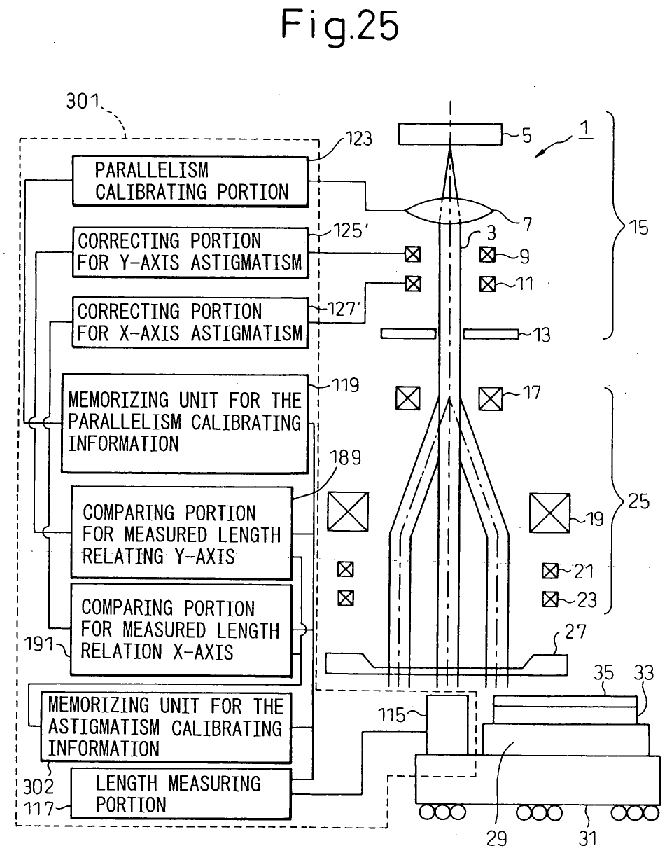

The method for the astigmatism adjustment shown in FIG. 23 is achieved with higher accuracy by using the astigmatism calibrating information, which is described with reference to the parallelism/astigmatism adjustment device 101 in FIG. 10. FIG. 25 is a schematic diagram of the electron-beam proximity exposure apparatus 1 having the parallelism/astigmatism adjustment device 301 which comprises the memorizing unit for the astigmatism calibrating information 302 in addition to the configuration of the parallelism/astigmatism adjustment device 201 in FIG. 22.

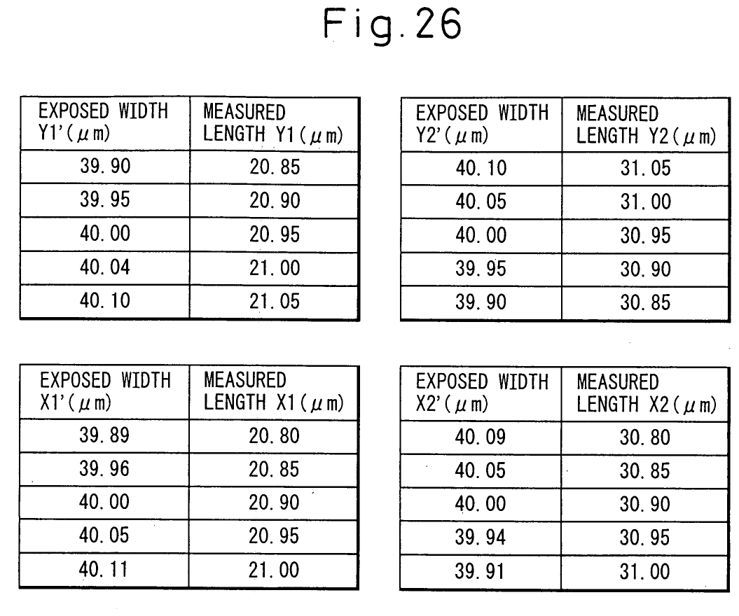

The astigmatism calibrating information memorized in the memorizing unit for the astigmatism calibrating information 302 contains the lengths measured in the directions of Y1, Y2, X1, and X2 which are the adjustable directions of Y-axis astigmatism correction coil 9 and X-axis astigmatism correction coil 9 by the length measuring portion 117, and line widths of the test pattern which has a predetermined width and is exposed on the resist layer 35, in relation to each other, in a plurality of state of a degree of the astigmatism. FIG. 26 is a table of examples of the astigmatism calibrating information.

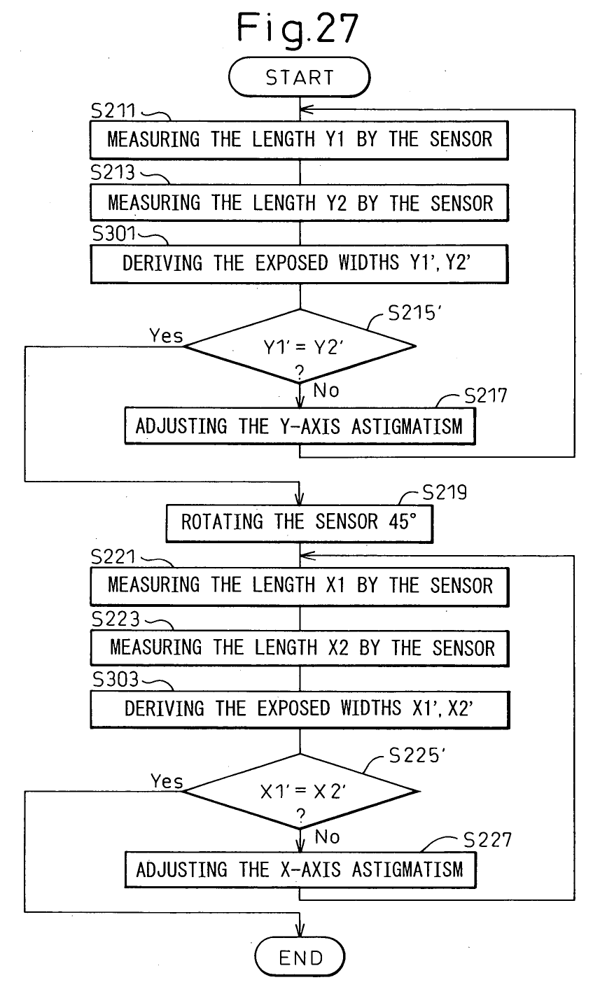

FIG. 27 is a flowchart of the method for the astigmatism adjustment of the device for the adjustment 301 shown in FIG. 25. Compared with the method for the astigmatism adjustment in FIG. 23, in the method shown in FIG. 25, the exposed line widths Y1′, Y2′, X1′ and X2′ which are memorized in relation to the measured lengths Y1, Y2, X1 and X2 measured by length measuring portion 117, is derived (S301, S303), and the comparing is performed between line widths Y1′ and Y2′, and between line widths X1′ and X2′ (S215′, S225′), instead of the comparing the measured lengths Y1 and Y2, X1 and X2 directly. Thus, the method shown in FIG. 27 can achieve the adjustment to a higher accuracy than the method shown in FIG. 23 because the widths of patterns actually exposed is compared for the astigmatism adjustment.

In addition, as shown in FIG. 26, there is no need that the measured length Y1 is equal to the measured length Y2 memorized in corresponding to the same width of the exposed patterns Y1′ and Y2′, and there is no need that the measured length X1 is equal to the measured length X2 corresponding to the same width of the exposed patterns X1′ and X2′. Thus, there is no need that the widths of the slits 129 used in the measuring length in directions of Y1, Y2, X1 and X2 axis are the same length. The detector 115 having slits 129 shown in FIG. 21C may be used instead of rotating the detector 115 as shown in FIG. 21A.

While the invention has been described with reference to specific embodiments chosen for purposes of illustration, it should be apparent that numerous modifications could be made thereto by those skilled in the art without departing from the basis concept and scope of the invention.

What is claimed is:

1. A method for adjusting an electron-beam of an electron-beam proximity exposure apparatus comprising the steps of:
forming the electron-beam, by passing it through an aperture which has a predetermined length part, into a measurement beam which has a cross section having a measurement part thereof corresponding to the predetermined length part of the aperture;
memorizing calibrating information, which includes beam state information and a measured length, wherein the beam state information indicates a state of the electron-beam, and the measured length is the length of the measurement part of the cross section of the measurement beam measured at a predetermined distance from the aperture under the state indicated the beam state information, and the measured length is memorized in relation to the state of the electron-beam indicated the beam state information;
measuring the length of the measurement part of the cross section of the measurement beam at a predetermined distance from the aperture; and
calibrating the state of the electron-beam of the electron-beam proximity exposure apparatus on the basis of the length measured in the measuring step in accordance with the calibrating information.

2. A method according to claim 1, wherein said state of the electron-beam is the state of a degree of the parallelism of the electron-beam, and said calibrating the state of the electron-beam is calibrating the state of a degree of the parallelism of the electron beam.

3. A method according to claim 1, wherein said state of the electron-beam is a degree of the astigmatism of the electron-beam, and said calibrating the state of the electron-beam is calibrating the state of a degree of the astigmatism of the electron beam.

4. A method for adjusting an electron-beam of the electron-beam proximity exposure apparatus comprising the steps of:
forming the electron-beam, by passing it through a aperture which has a predetermined length part, into a measurement beam which has a cross section having a measurement part thereof corresponding to the predetermined length part of the aperture;
measuring the length of the measurement part of the cross section of the measurement beam in two different directions at a predetermined distance from the aperture;
comparing the measured lengths related to two orthogonal directions; and
correcting a degree of the astigmatism of the electron-beam on the basis of the result of the comparison.

5. A device for adjusting an electron-beam of the electron-beam proximity exposure apparatus comprising:
an aperture which has a predetermined length part to form the electron-beam passing therethrough into a measurement beam which has a cross section having a measurement part thereof corresponding to the predetermined length part of the aperture;
a length measuring portion which measures the length of the measurement part of the cross section of the measurement beam at a predetermined distance from the aperture under a certain state of the electron-beam;
a memory unit which memorizes calibrating information including beam status information and a measured length, wherein the beam state information indicates a state of the electron-beam, and the measured length is the length of the measurement part of the cross section of the measurement beam measured at a predetermined distance from the aperture under the state indicated the beam status information, and the measured length is memorized in relation to the state of the electron-beam indicated the beam status information; and
a calibrating portion which calibrates the state of the electron-beam of the electron-beam proximity exposure apparatus on the basis of a length measured by the length measuring portion in accordance with the calibrating information.

6. A device according to claim 5, wherein said state of the electron-beam is the state of a degree of the parallelism of the electron-beam, and said calibrating portion calibrates the state of a degree of the parallelism of the electron beam.

7. A device according to claim 5, wherein said state of the electron-beam is a degree of the astigmatism of the electron-beam, and said calibrating portion calibrates the state of a degree of the astigmatism of the electron beam.

8. A device for adjusting an electron-beam of the electron-beam proximity exposure apparatus comprising:
a aperture which has a predetermined length part to form the electron-beam passing there through into a measurement beam which has a cross section having a measurement part thereof corresponding to the predetermined length part of the aperture;
a length measuring portion which measures the length of the measurement part of the cross section of the measurement beam in two different directions at a predetermined distance from the aperture;
a comparing portion which compares the measured lengths related to two orthogonal directions; and
a correcting portion which corrects a degree of the astigmatism of the electron-beam on the basis of the result of the comparison.

9. A device according to any one of claims 5 to 8, wherein said length measuring portion comprises a fluorescence plane and an image sensor for sensing the image of the cross section of the measurement beam generated on the fluorescence plane, wherein the fluorescence plane is disposed at a predetermined distance from the aperture.

10. A device according to claim 9, wherein the image sensor comprises a CCD photo acceptance unit.

11. A device according to any one of claims 5 to 8, wherein said length measuring portion comprises a Faraday cup with a knife-edge for detecting electrons in the measurement beam, a moving portion moving the Faraday cup with a knife-edge in a plane perpendicular to a beam axis of the electron-beam, and a profile generator which generates an electron-beam intensity profile at the measurement part of the cross section of the measurement beam on the basis of the output signal of the Faraday cup with a knife-edge, wherein the Faraday cup with a knife-edge is disposed at a predetermined distance from the aperture.
